(19) United States
(12) Patent Application Publication
(10) Pub. No.: US 2026/0113618 A1
(43) Pub. Date: Apr. 23, 2026

(54) INTERNATIONAL MOBILE SUBSCRIBER IDENTITY (IMSI) FOR A BOOTSTRAP PROFILE

(71) Applicant: T-Mobile USA, Inc., Bellevue, WA (US)

(72) Inventors: Kyeong Hun An, Sammamish, WA (US); Nilesh Ranjan, Sammamish, WA (US)

(21) Appl. No.: 18/920,815

(22) Filed: Oct. 18, 2024

(51) Int. Cl. H04W 8/18; H04W 12/06; H04W 12/72

(52) U.S. Cl. CPC H04W 8/183; H04W 12/06; H04W 12/72

(57) ABSTRACT

The present technology relates to provisioning an IMSI for a bootstrap profile of a wireless device attempting to download an eSIM profile from a network. The IMSI is selected from a range of IMSIs associated with an MNO of the network and stored on an eUICC. Upon selecting the IMSI, the wireless device accesses the wireless network using the bootstrap profile. The device receives an eSIM profile using the network access provided to the wireless device. The eSIM profile includes a different IMSI outside the range of IMSIs. The eSIM profile is then stored on the eUICC. Following the storage of the eSIM profile, the wireless device accesses the wireless network using the eSIM profile and deletes the first IMSI from the bootstrap profile.

### BACKGROUND

An Embedded Universal Integrated Circuit Card (eUICC) can include a bootstrap profile used to provision an Embedded Subscriber Identity Module (eSIM) on a wireless device. The bootstrap profile serves as an initial, temporary profile that enables the device to connect to a mobile network for the first time, even when Wi-Fi is not available to the device. This connection is crucial as it allows the device to download and install the actual operational profile, an eSIM profile associated with the user, from a remote server. The bootstrap profile typically contains a set of network credentials (e.g., an International Mobile Subscriber Identity (IMSI)) and configurations necessary to establish this initial connection. Once the device is connected, it can securely communicate with the mobile network operator's server to retrieve the full eSIM profile, which includes comprehensive network settings, authentication keys, and other essential data required for full network functionality. This process ensures that the eSIM can be provisioned over the air (OTA) without the need for a physical Subscriber Identity Module (SIM) card.

### BRIEF DESCRIPTION OF THE DRAWINGS

Detailed descriptions of implementations of the present invention will be described and explained through the use of the accompanying drawings.

FIG. 1 illustrates a wireless communications network that can implement aspects of the present technology.

FIG. 2 illustrates 5G core network functions (NFs) that can implement aspects of the present technology.

FIG. 3 illustrates an example operating environment in which one or more aspects of the present technology can be implemented.

FIG. 4 illustrates a method for provisioning an eSIM profile to a wireless device in accordance with aspects of the present technology.

FIG. 5 illustrates components of a computing device that can implement aspects of the present technology.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

An eUICC is a component of a wireless device that can store a network profile for accessing a wireless network provided by a mobile network operator (MNO). Unlike a SIM card, where the network profile may be physically coded onto the card, an eUICC can be remotely designed to support multiple network profiles and can be remotely provisioned and managed over the air (OTA). For example, the wireless device can communicate with the MNO to download an eSIM profile that includes user credentials, network authentication keys, security procedures, applications, and other elements used to access a wireless network of the MNO. Given that downloading the eSIM profile takes place OTA, wireless connectivity is needed to retrieve an eSIM profile from the MNO. Before the eSIM profile is provisioned, however, the wireless device may be unable to access the MNO through a cellular network.

The required connectivity can be, and often is, provided by Wi-Fi until the eSIM profile can be provisioned. For example, when first initializing a wireless device, a user may connect to a Wi-Fi network to download the eSIM profile from the MNO. When Wi-Fi is unavailable, however, the user must still be able to communicate with the MNO to receive the eSIM profile OTA. One solution to provide this connectivity is to store a bootstrap profile on the eUICC that is used to provide temporary connectivity until the eSIM profile can be downloaded from the MNO. The bootstrap profile can include its own credentials with which the wireless device can be authorized to access the network. Given that the bootstrap profile, in these circumstances, must be able to access the network without wireless connectivity, each device is developed with a unique IMSI within the bootstrap profile that enables the wireless device to connect to the wireless network through the bootstrap profile. This is the case even though very few users will ever need to access the wireless network without Wi-Fi in order to download the eSIM profile. Thus, this solution requires a large number of IMSIs that may never even be used to be authorized on the network, thereby wasting network resources and resulting in inefficiencies.

To reduce these inefficiencies and leverage the low probability that a large number of users will need to access the MNO, an IMSI provisioning module can be used to assign, to a bootstrap profile of a wireless device, on demand and without assigning a unique IMSI to a bootstrap profile of each wireless device developed, an IMSI that can be used to access a wireless network. Specifically, the MNO can provision a range of IMSIs authorized to access the network and intended to be used to provide temporary access to the network to allow a wireless device to access the network even when Wi-Fi connectivity is not available. An IMSI provisioning application (or applet, due to its small size and targeted functionality) can be installed on an eUICC of each wireless device developed. When Wi-Fi connectivity is not available to download an eSIM profile, the application can select an IMSI from a range of IMSIs stored on the eUICC and store the selected IMSI in an IMSI field of the bootstrap profile. The bootstrap profile, now having a set of credentials authorized to access the network, can be used to access the wireless network to download the eSIM profile. For example, the selected IMSI can be used to generate authentication keys that are used to access the network and download the eSIM profile.

Given that only a few users will have to download their eSIM profile without the benefit of Wi-Fi connectivity, a sufficiently large range of IMSIs will make it highly unlikely that two wireless devices will select and attempt to access the network using the same IMSI at any one time. For example, a range of 1,000, 10,000, 100,000, etc., IMSIs is likely sufficient to make collision very unlikely and yet this amount of IMSIs is still significantly less than if a unique IMSI was assigned to the bootstrap profile of each wireless device. To reduce the likelihood that two devices select the same IMSI at any one time, the IMSI can be selected randomly or pseudorandomly.

On the off chance that multiple devices select and attempt to access the network using the same IMSI, the network can send a reject message to the device. In response, the IMSI provisioning application of that device can select a different IMSI from the range to replace the rejected IMSI and attempt to access the network using the different IMSI. In this way, any concerns about collision caused by the use of the range of IMSIs across devices can be mitigated.

Once the eSIM is downloaded from the network, the eSIM profile can be stored on the eUICC and subsequently used to access the network. The eSIM profile can have a different IMSI that is intended to be used to for any subsequent requests to access the network. For example, subsequent network requests can utilize authentication keys associated with the different IMSI to access the network.

The IMSI stored in the bootstrap profile can be removed from the bootstrap profile to ensure that collisions do not occur if future devices attempt to use the IMSI to access the network (e.g., to download their respective eSIM without Wi-Fi connectivity). For example, when the bootstrap profile is used to access the network, the IMSI provisioning application can begin a timer that provides sufficient time for the eSIM profile to be downloaded. Then when the timer expires, and the eSIM profile is downloaded, the IMSI can be deleted from the bootstrap profile because it is no longer needed as the eSIM profile provides the device access to the network.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Wireless Communications System

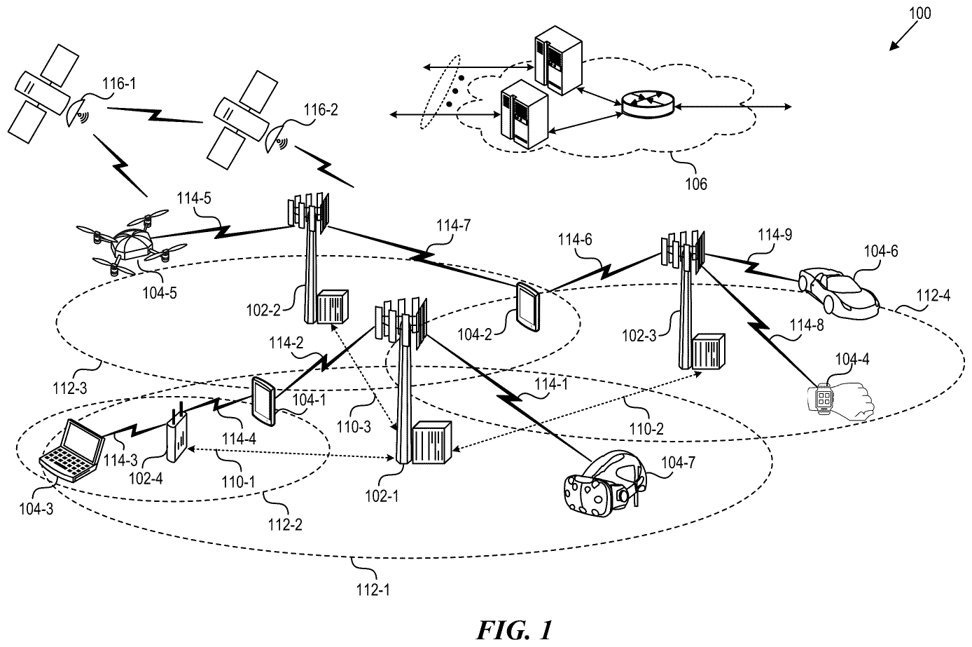

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 gigahertz (GHz) or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid Automatic Repeat Request (HARQ) to provide retransmission at the MAC layer to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of the network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The DL transmissions can also be called forward link transmissions while the UL transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a non-terrestrial network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service (QoS) requirements and multi-terabits-per-second data transmission in the era of 6G and beyond, such as terabit-per-second backhaul systems, ultra-high-definition content streaming among mobile devices, AR/VR systems, and wireless high-bandwidth secure communications. In another example of 6G, the network 100 can implement a converged Radio Access Network (RAN) and core architecture to achieve Control and User Plane Separation (CUPS) and achieve extremely low user plane latency. In yet another example of 6G, the network 100 can implement a converged Wi-Fi and core architecture to increase and improve indoor coverage.

### 5G Core Network Functions

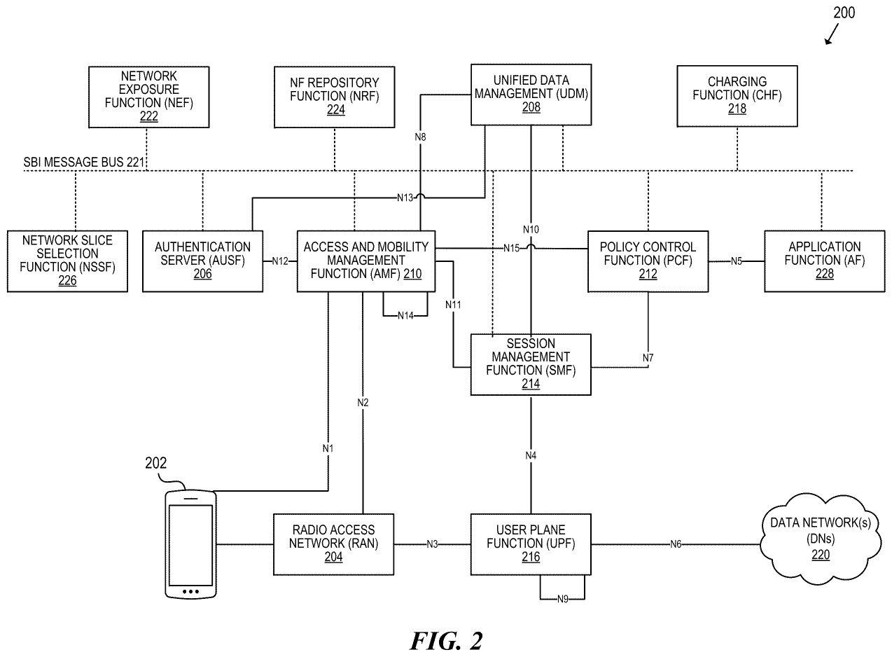

FIG. 2 is a block diagram that illustrates an architecture 200 including 5G core NFs that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility Management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service-Based Architecture (SBA) through a Service-Based Interface (SBI) 221 that uses Hypertext Transfer Protocol 2 (HTTP/2). The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given that a large number of wireless devices can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a data center, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### IMSI Provisioning Module

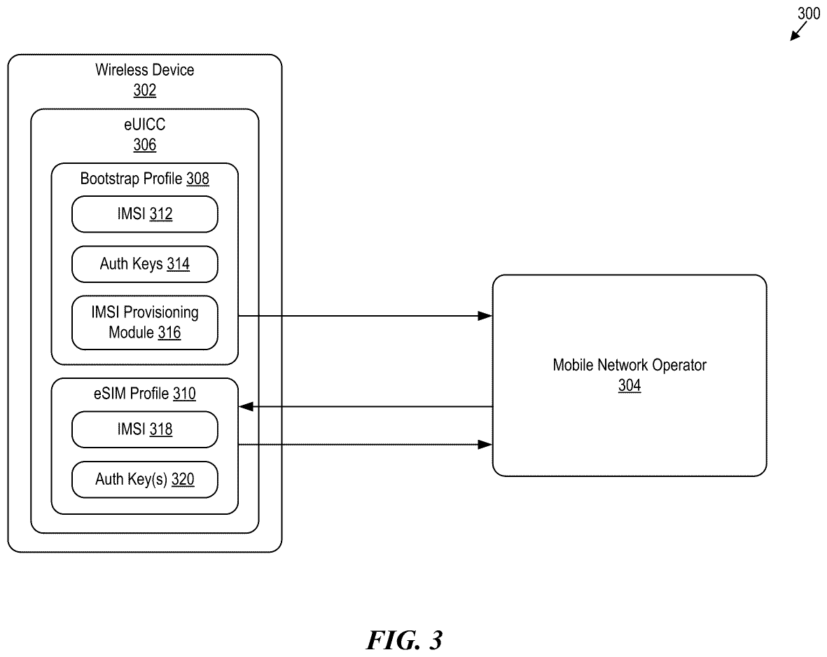

FIG. 3 illustrates an example operating environment 300 in which one or more aspects of the present technology can be implemented. The operating environment 300 includes a wireless device 302 and an MNO 304 capable of communicating with one another through a wireless network provided by the MNO 304. The communications can set up the wireless device 302 to communicate on the network provided by the MNO 304. In aspects, the communication can be performed through short-message service (SMS).

The wireless device 302 includes an eUICC 306, which can be built directly into the wireless device 302. The eUICC 306 can support multiple network profiles and can be remotely provisioned and managed over the air (OTA). This means that users can switch between different mobile network profiles without needing separate physical SIM cards. Although not shown, the eUICC 306 can also include space to implement additional applications, such as certain security features. Accordingly, the eUICC 306 can have various benefits over a traditional Universal Integrated Circuit Card (UICC).

The eUICC 306 includes a bootstrap profile 308 and an eSIM profile 310 that is downloaded using the bootstrap profile 308. Although not illustrated, the eUICC 306 can include additional eSIM profiles downloaded from the MNO 304 or other MNOs. The eUICC 306 can thus be used to provision, update, and manage the use of one or more eSIM profiles on the wireless device 302.

The bootstrap profile 308 can act as a startup eSIM profile used to download the eSIM profile 310 from the MNO 304. In aspects, the bootstrap profile 308 does not enable the device to perform any function other than making a connection to download the eSIM profile 310. The bootstrap profile 308 can be provisioned on the device at manufacture. The wireless device 302 can connect to the MNO 304 using bootstrap profile 308. For example, the bootstrap profile 308 can have an IMSI 312 and authentication keys 314 (e.g., a Subscriber Identity key (Ki) and a Derived Operator Code (OPC) key), which can be used to access the network provided by the MNO 304. In aspects, the authentication keys 314 can be generated using the IMSI 312 through logic at the bootstrap profile 308. In doing so, the particular authentication keys 314 used to access the network can be hidden to improve security. The authentication keys 314 can then be compared to the keys held by the MNO 304 (e.g., at an HSS/Home Subscriber Register (HLR)) to authenticate the wireless device 302 and provide access to the network. The bootstrap profile 308 thus enables the wireless device 302 to make an initial connection to the network to download the eSIM profile 310 (or multiple eSIM profiles) that will make it operational.

In other bootstrap profiles, the IMSI 312 is a unique IMSI provisioned at manufacture. In aspects, the IMSI 312 is not needed to connect with the MNO 304 to download the eSIM profile 310 when the wireless device 302 has Wi-Fi access, which describes most situations in which the eSIM profile 310 is downloaded. In these aspects, the IMSI 312 is only needed to download the eSIM profile 310 when Wi-Fi is not available. Thus, this technique for provisioning a unique IMSI for a bootstrap profile of each wireless device manufactured may be wasteful and inefficient.

To limit this waste, the bootstrap profile 308 is provisioned with an IMSI provisioning module 316 that determines the IMSI 312 in such a manner as to allow fewer IMSIs to be reserved for bootstrap profiles. The IMSI provisioning module 316 can include an applet on the bootstrap profile 308 (or on the eUICC 306 more generally). Thus, the IMSI provisioning module 316 can include machine-executable instructions that can be executed by a processor (e.g., a processor of the wireless device 302) to perform the functionality described herein.

The IMSI provisioning module 316 can select the IMSI 312 from a range of IMSIs authenticated by the MNO and reserved for bootstrap profiles accessing the network to download respective eSIM profiles. Given that only a small percentage of wireless devices will need to download their respective eSIM profiles while disconnected from Wi-Fi, the range of IMSIs can be significantly smaller than the number of wireless devices while still limiting the likelihood of collision between two devices. For example, the range of IMSIs can include 500, 1,000, 10,000, 100,000, 1,000,000, or any other number of IMSIs. Alternatively or additionally, the range of IMSIs can include a number of IMSIs equal to 5, 10, 15, 25, 50, or any number therebetween percent of subscribers on the wireless network. To further reduce the likelihood that two devices select and attempt to communicate with the network provided by the MNO 304 using the same IMSI, the IMSI 312 can be selected from the range of IMSIs in a random or pseudorandom manner.

Once selected, the IMSI 312 can be used to generate the authentication keys 314 for the bootstrap profile (e.g., through hashing, encryption, or any other techniques). In aspects, the authentication keys 314 can be generated in accordance with operational parameters provided by the MNO 304. When attempting to access the MNO 304 through the bootstrap profile 308, the wireless device 302 can communicate the authentication keys 314 with the request. The MNO 304 can then compare the received authentication keys 314 with authentication keys held by the MNO 304 (e.g., at the HSS/HLR). If the keys match, the wireless device 302 can be authenticated for communication on the network of the MNO 304, which can enable the wireless device 302 to download the eSIM profile 310 from the MNO 304.

While collision is unlikely, particularly as the number of IMSIs in the range of IMSIs increases, there is still a possibility that two wireless devices attempt to access the network of the MNO 304 at the same time using the same IMSIs (e.g., selected by respective IMSI provisioning modules on the devices). In such cases, the MNO 304 can send an authentication reject message to the wireless device 302. In response to the reject message, the IMSI provisioning module 316 can replace the IMSI 312 with a new IMSI selected from the range of IMSIs. Then, the authentication keys 314 can be regenerated using the new IMSI to access the wireless network provided by the MNO 304.

Once the wireless device 302 is authenticated and has access to the network, the MNO 304 sends the eSIM profile 310 to the wireless device. The eSIM profile 310 includes an IMSI 318 different from the IMSI 312. The IMSI 318 can be outside the range of IMSIs and intended to be used for full operation of the wireless device 302 (e.g., in contrast to the IMSI 312 used only to provision the eSIM profile 310 on the wireless device 302). In aspects, the eSIM profile 310 may not include the authentication keys 320 when transmitted from the MNO 304. Instead, the authentication keys 320 can be generated from the IMSI 318, like the authentication keys 314 with respect to IMSI 312, using operations dictated by the MNO 304 (e.g., through procedures in the eSIM profile 310).

The eSIM profile 310 can be downloaded to the eUICC 306, for example, using a subscription manager (SM). The SM can be responsible for downloading, installing, and managing operator profiles on the wireless device 302. For example, a subscription manager-data preparation (SM-DP) (not shown) can store the eSIM profile 310 and deliver it to the eUICC 306. Once downloaded, a subscription manager-secure routing (SM-SR) (not shown) can manage profile status and ensure that profile data is transferred securely. For example, the SM-SR can tell the eUICC 306 to disable, enable, or delete a profile. In this case, it can enable the eSIM profile 310.

Once the eSIM profile 310 is enabled, the eSIM profile 310 can be used to access the network provided by the MNO 304. For example, the wireless device 302 can access the network by transmitting the authentication keys 320. Once authenticated, the wireless device 302 can communicate on the network provided by the MNO 304 using the eSIM profile 310.

The IMSI 312 and the authentication keys 314 can then be deleted from the bootstrap profile 308 to ensure that they are available for future downloads of respective eSIM profiles by other wireless devices. For example, the IMSI provisioning module 316 can delete the IMSI 312 and the authentication keys 314 once a predetermined amount of time has passed since the bootstrap profile 308 was used to access the network. The amount of time can be sufficient to enable the wireless device 302 to download the eSIM profile 310 from the MNO 304. For example, the IMSI 312 can be deleted 10 minutes, 30 minutes, one hour, two hours, or any other amount of time after the bootstrap profile 308 is used to access the network provided by the MNO 304. In deleting the IMSI 312 and the authentication keys 314, the wireless device 302 can no longer access the network using the bootstrap profile 308, at least until a new IMSI is provisioned by the IMSI provisioning module 316 (e.g., in response to a re-initialization of the wireless device 302).

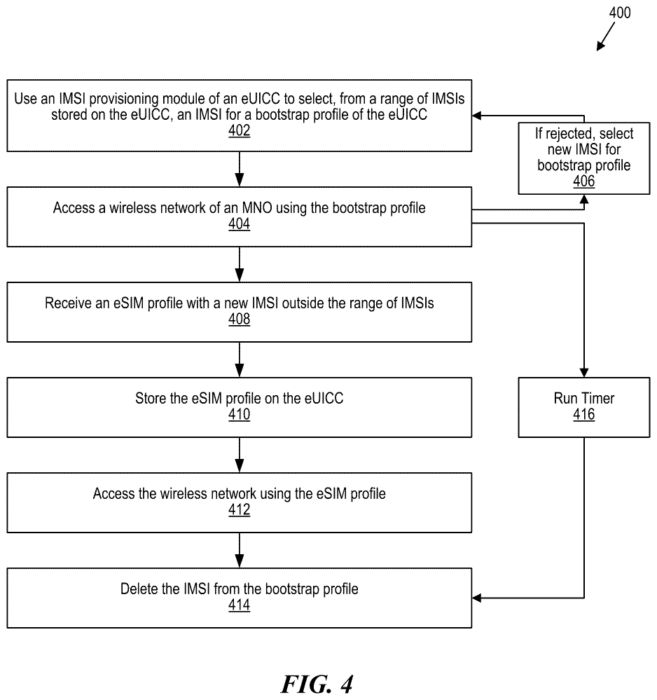

FIG. 4 illustrates a method 400 for provisioning an eSIM profile to a wireless device in accordance with aspects of the present technology. Although illustrated in a particular configuration, one or more operations of the method 400 may be omitted, repeated, or reorganized. Additionally, the method 400 may include other operations not illustrated in FIG. 4, for example, operations detailed in one or more other methods described herein. In aspects, one or more of the operations of the method 400 occur when no Wi-Fi network is available for use in downloading an eSIM profile to a wireless device. For example, one or more operations of the method 400 can occur in response to determining that no Wi-Fi connection is available to download the eSIM profile.

At 402, an IMSI provisioning module of an eUICC of the wireless device selects an IMSI for a bootstrap profile of the eUICC. The IMSI for the bootstrap profile can be selected from a range of IMSIs associated with an MNO of the network. For example, the range of IMSIs (or authentication information associated with the IMSIs, such as authentication keys generated from the IMSIs) can be stored by the MNO such that wireless devices accessing the network using any IMSI in the range of IMSIs are authenticated and provided access to the network. The range of IMSIs can be allocated to bootstrap profiles to be used in provisioning eSIM profiles to devices. Thus, in some embodiments, none of the IMSIs in the range of IMSIs are provisioned to a wireless device within a fully functional eSIM profile.

The range of IMSIs can be stored on the eUICC (e.g., within the bootstrap profile) to enable the IMSI provisioning module to select an IMSI from the range of IMSIs. The IMSI provisioning module can select the IMSI from the range through a random or pseudorandom process. For example, the IMSI can be selected based on a seed defined by a sensor of the wireless device. Once the IMSI has been selected, it can be stored in a bootstrap profile of the eUICC, for example, at an empty IMSI field of the bootstrap profile. In aspects, the IMSI field is empty (e.g., filled with a random, non-functional value, a zero value, or a NULL value) because an IMSI has yet to be provisioned to the bootstrap profile. In other cases, an IMSI was provisioned to the bootstrap profile but later deleted, leaving the IMSI field empty. In yet other aspects, the IMSI selected by the IMSI provisioning module can replace an old IMSI value still stored in the bootstrap profile.

At 404, the bootstrap profile is used to access the wireless network provided by the MNO. For example, the IMSI of the bootstrap profile can be used to generate authentication keys (e.g., through hashing or any other cryptographic process) used to access the network. The authentication keys can be generated based on procedures defined by the MNO (e.g., procedures stored in the bootstrap profile). The authentication keys can then be provided by the wireless device to the MNO to authenticate the wireless device. For example, the authentication keys can be compared to authentication keys stored at the network (e.g., in an HSS/HLR of the network) to determine if the authentication keys match. If so, the wireless device can be granted access to the network to enable the wireless device to download the eSIM profile.

If the authentication keys do not match or if a different wireless device is already authenticated on the network using an IMSI stored in the bootstrap profile, the network can communicate a reject message to the wireless device. The wireless device can respond to the reject message by attempting to access the network using a new IMSI, at 406. For example, the IMSI currently stored in the bootstrap profile can be replaced with a new IMSI selected from the range of IMSIs (e.g., by deleting the old IMSI and storing the new IMSI). Once the new IMSI is stored, the updated bootstrap profile can be used to access the network, at 404. For example, the new IMSI can be used to regenerate the authentication keys, and the authentication keys can be transmitted to the MNO to authenticate the wireless device.

Once the wireless device is authenticated using the bootstrap profile and the wireless device is provided access to the network, the wireless device can receive the eSIM profile from the MNO through the network, at 408. The eSIM profile can provide full functionality to the wireless device on the network (e.g., compared to the bootstrap profile, which can be limited to allow only the download of the eSIM profile or other setup functionality). The eSIM profile can include a different IMSI outside the range of IMSIs. For example, the IMSI can be associated with an account with the MNO affiliated with a user of the wireless device and capable of being used to provide the full functionality to which the user has subscribed on the network.

At 410, the eSIM profile can be stored on the eUICC. The eSIM profile can be downloaded and managed on the wireless device using an SM. For example, an SM-DP can store the eSIM profile on the eUICC. The eUICC can store multiple profiles to enable access to different networks or different network features. Thus, the eSIM profile can be stored without overwriting a different eSIM profile currently stored on the eUICC.

At 412, the wireless device accesses the wireless network using the eSIM profile. For example, an SM-SR can manage profile status by causing the eUICC to disable, enable, or delete a profile. In this case, it can enable the downloaded eSIM profile. In some cases, the eUICC can enable or disable a profile based on an indication from the user of the wireless device. For example, the user can select the eSIM profile (e.g., using a display or other input system on the wireless device), thereby causing the eUICC to make the eSIM the active profile. In other cases, the active profile can be selected by determining which profile provides the desired functionality on the available network. For example, the eUICC can make the eSIM profile active over the bootstrap profile due to its increased functionality.

When a particular profile (e.g., the eSIM profile) is active, the authentication keys of that profile can be used to authenticate the wireless device. For example, the IMSI of the eSIM profile can be used to generate authentication keys that can be used to access the network and any services subscribed to by the user. The authentication keys can accompany a request to access the network. When received by the network, the authentication keys can be compared to authentication keys stored at the network. If the keys match, the wireless device can be authenticated and provided the services on the network to which the user is subscribed.

At 414, the IMSI is deleted from the bootstrap profile. For example, the IMSI provisioning module can delete the bootstrap profile to ensure that the IMSI is available for future off-Wi-Fi downloads on other devices. The IMSI of the bootstrap profile can be deleted after the eSIM profile is downloaded to ensure that the device is not left without connectivity. For example, the IMSI can be deleted from the bootstrap profile in response to the wireless device successfully accessing the wireless network using the eSIM profile.

In yet other aspects, at 416, a timer can be initiated when the bootstrap profile is used to access the wireless network, and at 414, the IMSI can be deleted from the bootstrap profile when the timer expires. The timer can be used to ensure that the wireless device has connectivity for enough time to download the eSIM profile but also to ensure that the IMSI is not used by the wireless device indefinitely. Thus, the timer can be for a time longer than it takes to download the eSIM profile while still being short enough to make the IMSI available for other devices and reduce the likelihood of collision (e.g., 5 minutes, 15 minutes, 30 minutes, 1 hour, 2 hours, or any other amount of time).

In this way, the method 400 can enable an off-Wi-Fi download of the eSIM profile using a temporary IMSI provisioned for a bootstrap profile from a range of IMSIs that are shared and assignable to multiple devices. By allowing for multiple devices to perform the off-Wi-Fi download (e.g., at different times) using the same IMSI, the number of IMSIs reserved on the network for initiating the device and downloading an initial eSIM profile can be reduced.

### Computing System

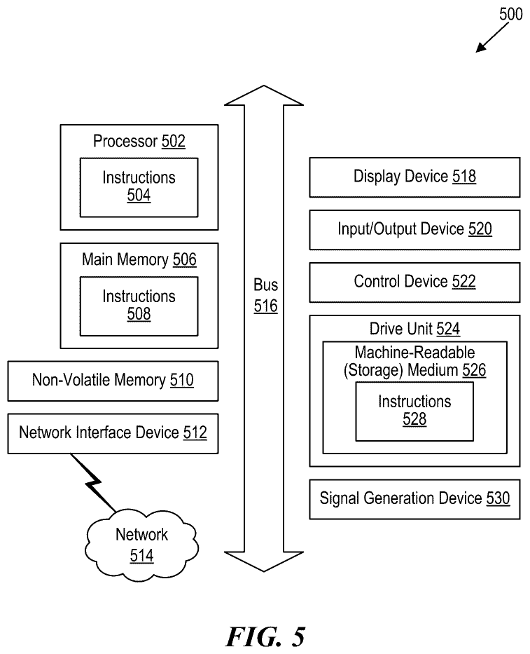

FIG. 5 is a block diagram that illustrates an example of a computing system 500 in which at least some operations described herein can be implemented. As shown, the computing system 500 can include one or more processors 502, main memory 506, non-volatile memory 510, a network interface device 512, a display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computing system 500 is intended to illustrate a hardware device on which components illustrated or described relative to the examples of the figures and any other components described in this specification can be implemented.

The computing system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR system (e.g., head-mounted display), or any electronic device capable of executing a set of instructions that specifies action(s) to be taken by the computing system 500. In some implementations, the computing system 500 can be an embedded computing system, a system-on-chip (SOC), a single-board computing (SBC) system, or a distributed system such as a mesh of computing systems, or it can include one or more cloud components in one or more networks. Where appropriate, one or more computing systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable (storage) medium 526) can be local, remote, or distributed. Although shown as a single medium, the machine-readable (storage) medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable (storage) medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A wireless device comprising:
at least one hardware processor; and
at least one non-transitory memory storing instructions that, when executed by the at least one hardware processor, cause the wireless device to:
select, to fill an empty International Mobile Subscriber Identity (IMSI) value of a bootstrap profile of an Embedded Universal Integrated Circuit Card (eUICC) of the wireless device and using an IMSI provisioning module located on the eUICC, a first IMSI from a range of IMSIs stored on the eUICC, the range of IMSIs associated with a mobile network operator;
in response to selecting the first IMSI, access a wireless network of the mobile network operator using the first IMSI of the bootstrap profile;
in response to accessing the wireless network of the mobile network operator using the first IMSI, receive, over the wireless network, an Embedded Subscriber Identity Module (eSIM) profile comprising a second IMSI associated with the mobile network operator and outside of the range of IMSIs;
store, at the eUICC, the eSIM profile;
in response to storing the eSIM profile, access the wireless network using the second IMSI of the eSIM profile; and
delete the first IMSI of the bootstrap profile from the bootstrap profile.

2. The wireless device of claim 1, wherein the instructions further cause the wireless device to:
determine that a Wi-Fi connection is unavailable; and
select the first IMSI in response to determining that the Wi-Fi connection is unavailable.

3. The wireless device of claim 1, wherein the instructions further cause the wireless device to:
in response to accessing the wireless network using the first IMSI of the bootstrap profile, start a timer; and
delete the first IMSI from the bootstrap profile in response to expiration of the timer.

4. The wireless device of claim 1, wherein the instructions further cause the wireless device to:
prior to selecting the first IMSI, select, to fill the empty IMSI value of the bootstrap profile, a third IMSI from the range of IMSIs, the third IMSI different from the first IMSI;
in response to selecting the first IMSI, fail to access the wireless network of the mobile network operator using the third IMSI of the bootstrap profile; and
in response to failing to access the wireless network using the third IMSI:
delete the third IMSI from the bootstrap profile; and
select the first IMSI.

5. The wireless device of claim 1, wherein the instructions further cause the wireless device to select the first IMSI from the range of IMSIs using a random or pseudorandom process.

6. The wireless device of claim 1, wherein the instructions further cause the wireless device to:
in response to selecting the first IMSI, generate a first authentication key of the bootstrap profile using the first IMSI; and
access the wireless network using the first authentication key of the bootstrap profile.

7. The wireless device of claim 1, wherein the instructions further cause the wireless device to:
in response to storing the eSIM profile at the eUICC, receive an input to activate the eSIM profile; and
in response to receiving an input to activate the eSIM profile, access the wireless network using the second IMSI of the eSIM profile.

8. The wireless device of claim 1, wherein the range of IMSIs comprise at least 1,000 IMSIs.

9. At least one non-transitory, computer-readable storage medium storing instructions, which, when executed by at least one data processor of a system, cause the system to:
select, for a first profile of an Embedded Universal Integrated Circuit Card (eUICC) and using an International Mobile Subscriber Identity (IMSI) provisioning module located on the eUICC, a first IMSI from a range of IMSIs stored on the eUICC, the range of IMSIs associated with a mobile network operator;
in response to selecting the first IMSI, access a wireless network of the mobile network operator using the first IMSI of the first profile;
in response to accessing the wireless network of the mobile network operator using the first IMSI, receive, over the wireless network, an Embedded Subscriber Identity Module (eSIM) profile comprising a second IMSI associated with the mobile network operator and outside of the range of IMSIs;
store, at the eUICC, the eSIM profile; and
in response to storing the eSIM profile, access the wireless network using the second IMSI of the eSIM profile.

10. The at least one non-transitory, computer-readable storage medium of claim 9, wherein the instructions further cause the system to:
determine that a Wi-Fi connection is unavailable; and
select the first IMSI in response to determining that the Wi-Fi connection is unavailable.

11. The at least one non-transitory, computer-readable storage medium of claim 9, wherein the instructions further cause the system to:
in response to accessing the wireless network using the first IMSI of the first profile, start a timer; and
delete the first IMSI from the first profile in response to expiration of the timer.

12. The at least one non-transitory, computer-readable storage medium of claim 9, wherein the instructions further cause the system to:
prior to selecting the first IMSI, select, for the first profile, a third IMSI from the range of IMSIs, the third IMSI different from the first IMSI;
in response to selecting the first IMSI, fail to access the wireless network of the mobile network operator using the third IMSI of the first profile; and
in response to failing to access the wireless network using the third IMSI:
delete the third IMSI from the first profile; and
select the first IMSI.

13. The at least one non-transitory, computer-readable storage medium of claim 9, wherein the instructions further cause the system to select the first IMSI from the range of IMSIs using a random or pseudorandom process.

14. The at least one non-transitory, computer-readable storage medium of claim 9, wherein the instructions further cause the system to:
in response to selecting the first IMSI, generate a first authentication key of the first profile using the first IMSI; and
access the wireless network using the first authentication key of the first profile.

15. The at least one non-transitory, computer-readable storage medium of claim 9, wherein the instructions further cause the system to:
in response to storing the eSIM profile at the eUICC, receive an input to activate the eSIM profile; and
in response to receiving an input to activate the eSIM profile, access the wireless network using the second IMSI of the eSIM profile.

16. The at least one non-transitory, computer-readable storage medium of claim 9, wherein the range of IMSIs comprise at least 1,000 IMSIs.

17. A method comprising:
selecting, for a first profile of an Embedded Universal Integrated Circuit Card (eUICC) and using an International Mobile Subscriber Identity (IMSI) provisioning module located on the eUICC, a first IMSI from a range of IMSIs stored on the eUICC, the range of IMSIs associated with a mobile network operator;
in response to selecting the first IMSI, accessing a wireless network of the mobile network operator using the first IMSI of the first profile;
in response to accessing the wireless network of the mobile network operator using the first IMSI, receiving, over the wireless network, an Embedded Subscriber Identity Module (eSIM) profile comprising a second IMSI associated with the mobile network operator and outside of the range of IMSIs;
storing, at the eUICC, the eSIM profile; and
in response to storing the eSIM profile, accessing the wireless network using the second IMSI of the eSIM profile.

18. The method of claim 17, further comprising:
in response to accessing the wireless network using the first IMSI of the first profile, starting a timer; and
deleting the first IMSI from the first profile in response to expiration of the timer.

19. The method of claim 17, further comprising selecting the first IMSI from the range of IMSIs using a random or pseudorandom process.

20. The method of claim 17, wherein the range of IMSIs comprise at least 1,000 IMSIs.
